(19) United States
(12) Patent Application Publication
(10) Pub. No.: US 2011/0320478 A1
(43) Pub. Date: Dec. 29, 2011

(54) USER MANAGEMENT OF ELECTRONIC DOCUMENTS

(75) Inventors: Christina Rene Carlson, Chanhassen, MN (US); Jason A. Collier, Durham, NC (US); Heidi Katherine Ludewig, Durham, NC (US)

(73) Assignee: INTERNATIONAL BUSINESS MACHINES CORPORATION, ARMONK, NY (US)

(21) Appl. No.: 12/825,879

(22) Filed: Jun. 29, 2010

(51) Int. Cl. G06F 17/30

(52) U.S. Cl. 707/769; 707/E17.014

(57) ABSTRACT

Described is the user management of electronic documents. Content selected from a first electronic document is received. Metadata are generated corresponding to the received selected content and a location of the received content in the first electronic document. The metadata are stored and a search term is subsequently received that is also in the received content. In response to a search against a repository, search results are displayed. The search results include an indicator of the first electronic document and an indicator of a second electronic document that includes the search term. The indicator of the first electronic document is displayed higher in the search results than the second electronic document.

### FIELD OF THE INVENTION

The present invention relates generally to the user management of electronic documents. In particular, the present invention is directed to systems and methods that allow a user to assign metadata to content in a document selected by a user as being important, wherein when a search is subsequently performed for a keyword in the documents, a document containing the keyword to which the metadata corresponds is prioritized in the search results listing.

### BACKGROUND

Document management systems are widely used by businesses and individual users to organize, store, and retrieve electronic documents, for example, email messages, web pages, electronic files, etc. However, users often store and categorize large numbers of documents with the intent of retrieving the documents in the future. As the number of stored documents, for example, saved email messages, continues to increase, difficulties can arise in quickly and effectively retrieving a stored document according to its contents.

Several approaches are available for retrieving electronic documents via a search. In one approach, keyword searching is performed when a user wants to locate a document containing words or phrases that are descriptive and specific to the document. Here, the user enters a search term (keyword or phrase) into a search tool on the user's computer. In response, a document management system searches the computer and/or other storage devices external to the computer, for example, servers and databases, for documents containing words or phrases that match the search term, and displays a list of search results.

Keyword searching places little explicit priority on particular keywords during a search, and instead performs simple searches for keywords that match the search term, or using statistical rules to take into consideration keyword density, uniqueness, spatial relationship, etc. In this approach, all words are valued equally with regard to the search results, and there is little or no intelligence other than the application of conventional statistical rules and/or pattern matching features. Accordingly, highly relevant documents may not appear at the top of search results page.

In another approach, keyword tags are used to search for information. Here, user documents such as web pages are tagged with relevant keywords that are descriptive to the document. The keyword tags are generated either automatically via a rules system or are set explicitly by a human. Accordingly, keyword tags can be used to ensure that corresponding documents are considered to be higher in relevance than documents with no keyword tags. However, although documents comprising tagged keywords can be prioritized over other documents, the priority tags are not alterable by the user. Also, keyword tagging prevents other search methods from being performed. In other words, keyword tags are prioritized over other words in the document so that there is no way to search a document's contents for words other than those with explicitly set tags. There remains a need, therefore, for a system and method for managing documents that are tailored to the personal interests of a user and for enabling application programs to permit users to manage their email messages, web pages, and other electronic documents according to the requirements set forth by the user.

### SUMMARY

In one aspect, the invention features a computer-implemented method of managing a plurality of electronic documents. In the method, selected content from a first electronic document is received. Metadata are generated corresponding to the received content and a location of the received content in the first electronic document. The metadata are stored. A search term that is also in the received content is received. Search results are displayed in response to a search against a repository, the search results including an indicator of the first electronic document and further including an indicator of a electronic document including the search term. The indicator of the first electronic document is displayed higher in the search results than the second electronic document.

In another aspect, the invention features a document management system that comprises a document manager that receives from a user device content selected from a first electronic document and that generates metadata corresponding to the received content and a location of the received content in the first electronic document. The document management system further comprises a data repository that stores the metadata. When a search is performed against a repository for electronic documents that include a search term, an indicator of the first electronic document is displayed in the user device higher in the search results than an indicator of a second electronic document that includes the search term.

In another aspect, the invention features a computer program product for managing a plurality of electronic documents. The computer program product comprises a computer readable storage medium having computer readable program code embodied therewith. The computer readable program code comprises computer readable program code configured to receive content selected from a first electronic document. Computer readable program code is configured to generate metadata corresponding to the received content of the received content and a location of the selected content in the electronic document. Computer readable program code is configured to store the metadata. Computer readable program code is configured to subsequently receive a search term. Computer readable program code is configured to display search results in response to a search. The search results include an indicator of the first electronic document and further include an indicator of a second electronic document including the search term. The indicator of the first electronic document is displayed higher in the search results than the second electronic document.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a document management system, in accordance with the principles of the invention.

FIG. 2 is a flow diagram of an embodiment of a process for managing electronic documents, in accordance with the principles of the invention.

FIGS. 3A and 3B are screenshots of an email message, wherein contents of the email message are selected by a first user and a second user, respectively, in accordance with principles of the invention.

### DETAILED DESCRIPTION

In the following description, specific details are set forth although it should be appreciated by one of ordinary skill that the present invention can be practiced without at least some of the details. In some instances, known features or processes are not described in detail so as not to obscure the present invention.

The present invention features systems and methods that provide user management of electronic documents. According to an embodiment, a user can identify, select, and electronically mark certain terms, images, or other relevant objects in a document as being of importance to the user. In doing so, the user can later perform a search for electronic documents that contain a word, phrase, graphic, etc. identified in a search request. If the search request produces in its results the document containing the term, image, etc. previously identified and marked by the user, this document appears in the search results, and, more importantly, appears in a higher position in the search results than the other documents that also contain the term, image, etc. in the search request. This is achieved in part by assigning metadata to the selected contents of the document of interest to the user, which permits the selected contents to achieve higher rankings in the search results. Accordingly, the systems and methods described herein can be used with online and offline email systems, desktop search systems, Internet and intranet search engines, database management systems, and content management systems.

Although the embodiments below primarily refer to a method, it will be appreciated by one skilled in the art that aspects of the present invention may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

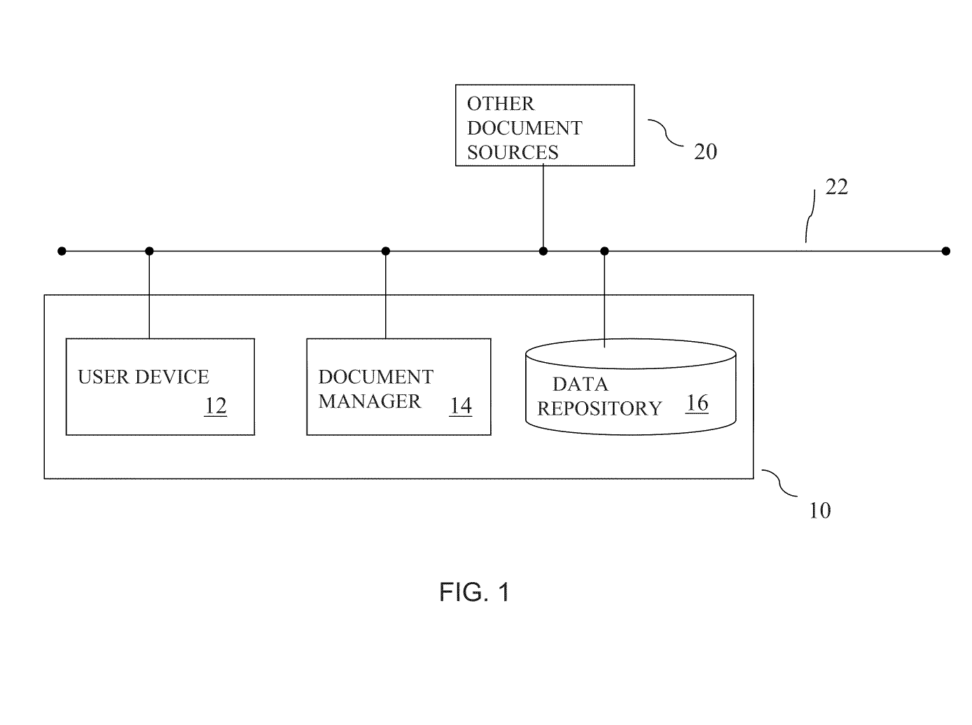

FIG. 1 is a block diagram of a document management system 10, in accordance with aspects of the invention. The document management system 10 comprises a user device 12, a document manager 14, and a data repository 16. The user device 12, document manager 14, and/or data repository 16 can be collocated under a single hardware platform, including, but not limited to, a desktop computer, laptop computer, server system, hand-held device such as a personal digital assistant (PDA), a cellular phone, and a network terminal. Alternatively, the user device 12, document manager 14, and/or data repository 16 can be separate physical devices, in communication with each other via a direct connection, or through any type of network, for example, network types described herein.

The user device 12 includes components known to those of ordinary skill in the art for inputting information and commands to the document manager 14 and data repository 16, and for receiving information from the document manager 14 and data repository 16. The user device components can include, but not be limited to, a monitor or display, one or more user-input devices, e.g., a keyboard, a mouse, trackball, and the like, non-removable non-volatile storage media, for example, hard disks, CD ROMs, and the like, and/or other peripheral devices, for example, printers.

The user device 12 includes one or more software applications that execute entirely on the user device 12, partly on the user device 12, as a stand-alone software package, partly on the user device 12 and partly on a remote computer in communication with the user device 12, for example, an email server, or entirely on a remote computer server. Software applications include, but not limited to word processing applications, email applications, web browsers, and/or other applications that receive and/or produce electronic documents.

During operation, a user generates a document, for example, an email message, word processing document, or other document comprising content such as text, images, or other forms of visual presentation. During operation, the user identifies and selects content in the document, such as words, phrases, sentences, or paragraphs that are deemed important to the user. The content can be selected by highlighting, click-drag, voice input, designated button input, touch screen input, etc.

The user categorizes the selected content by its level of importance or relevance to the user. For example, after highlighting the text of an email message, the user clicks a button on the email application identified as “mark as important.” The button may be located in a context menu in the same application that is to generate the text, or may be in a different application such as in an email application or word processing application. The text can be identified by a highlighted background color, underline, italics, and the like to indicate a level of importance.

The selected content is provided to the document manager 14, which assigns metadata to the selected content, in particular, to keywords in the selected content that may be searched during subsequent search queries by the author of the document or by other interested users. The metadata include data about the subjective relevance and importance of the document contents, such data including, for example, location of the selected content in the document, In this manner, a search tool, for example, an intranet search engine, can index the metadata according to the relevance and/or importance of the document content.

The document including the selected content deemed to be of importance to the user is stored in the data repository 16. In particular, the selected contents in the document and/or the locations of the selections are stored as metadata in the data repository 16. Other documents including search terms, metadata, tags, keywords, selected text, images, and the like can also be stored in the data repository 16. Other documents can be provided to the repository 16 from other document sources 20, for example, other databases, servers, Internet websites, etc.

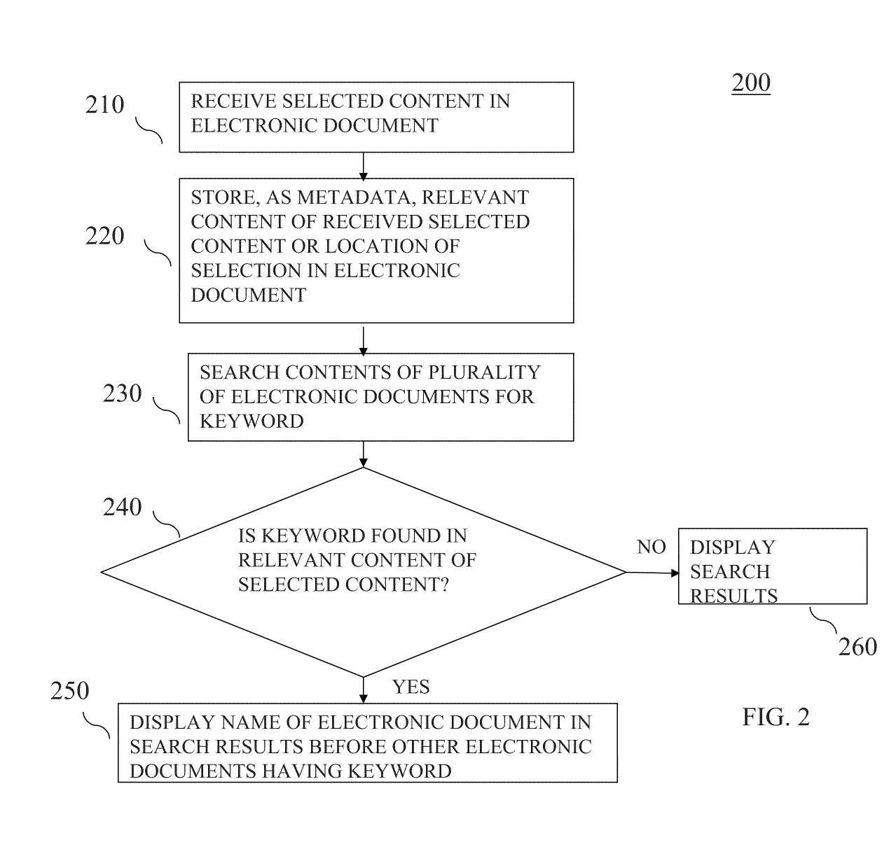

FIG. 2 is a flow diagram of an embodiment of a process 200 for managing electronic documents, in accordance with the principles of the invention. The process 200 can be performed by the document management system 10 shown in FIG. 1.

At step 210, selected content in an electronic document can be received by the document manager 14. The electronic document can include, but is not limited to, an email message, web page, word processing document, scanned document, for example, including handwriting, communication session, for example, text messaging, or other electronic documents known to those of ordinary skill in the art. The document manager 14 generates metadata corresponding to at least one of relevant content of the received selected content and a location of the selected content in the electronic document.

At step 220, the relevant content of the received selected content are stored as metadata. In another embodiment, the locations of the selected content in the electronic document are stored as metadata.

At step 230, a search is performed to locate one or more electronic documents by matching the term(s) in the search query with the contents of the documents discovered during the search. In other embodiments, a search is performed for documents including other types of data, for example, images or other forms of visual presentation. The search is performed by a search tool known to those of ordinary skill in the art, for example, a search engine, or other search tool capable of processing metadata. The search is performed on the repository 16, or is performed on one or more document sources 20 that are separate from the repository 16, but in communication with the document manager 14, for example, via a network 22.

At step 240, a determination is made as to whether the search term in the search query is found in the relevant content of the document selected by the user. This determination can be made by the search tool. If the keyword is found in the relevant content of the selected content (e.g., YES), then information pertaining to the electronic document, for example, the document name, is determined to be of higher importance than the other electronic documents including the search term, and is accordingly displayed (step 250) in the search results before the other electronic documents. If the keyword is not found in the relevant content of the selected content (e.g., NO), the document is displayed (step 260) in the search results according to the search parameters set forth by the search tool.

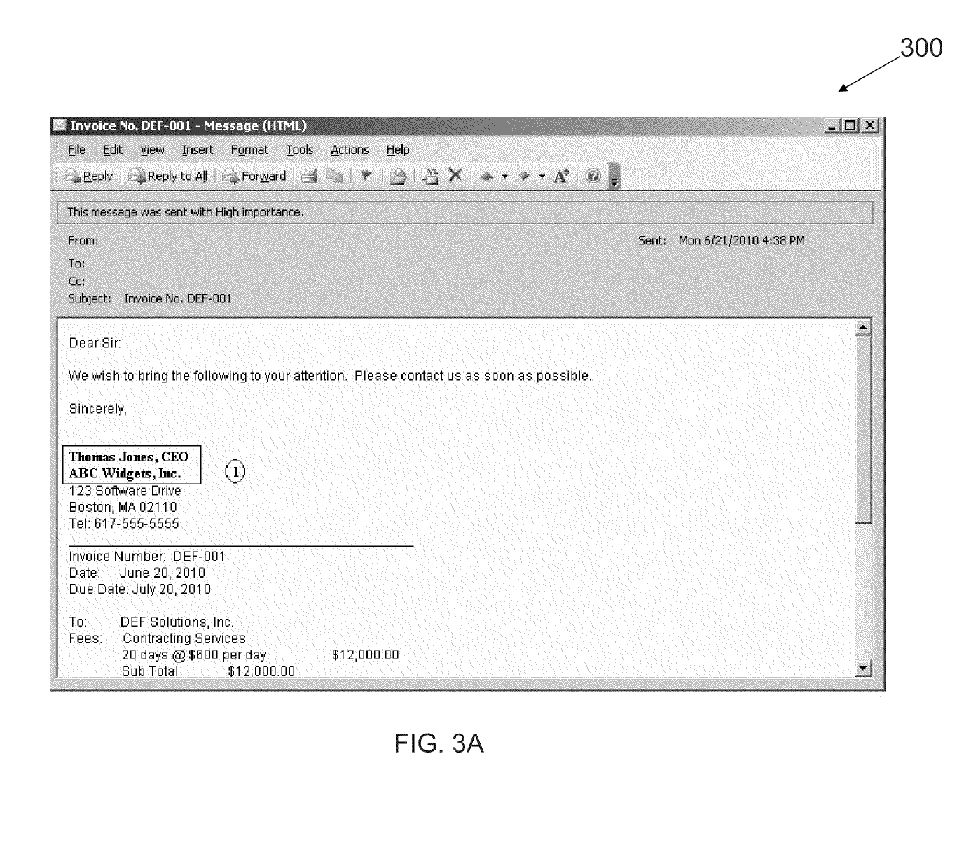

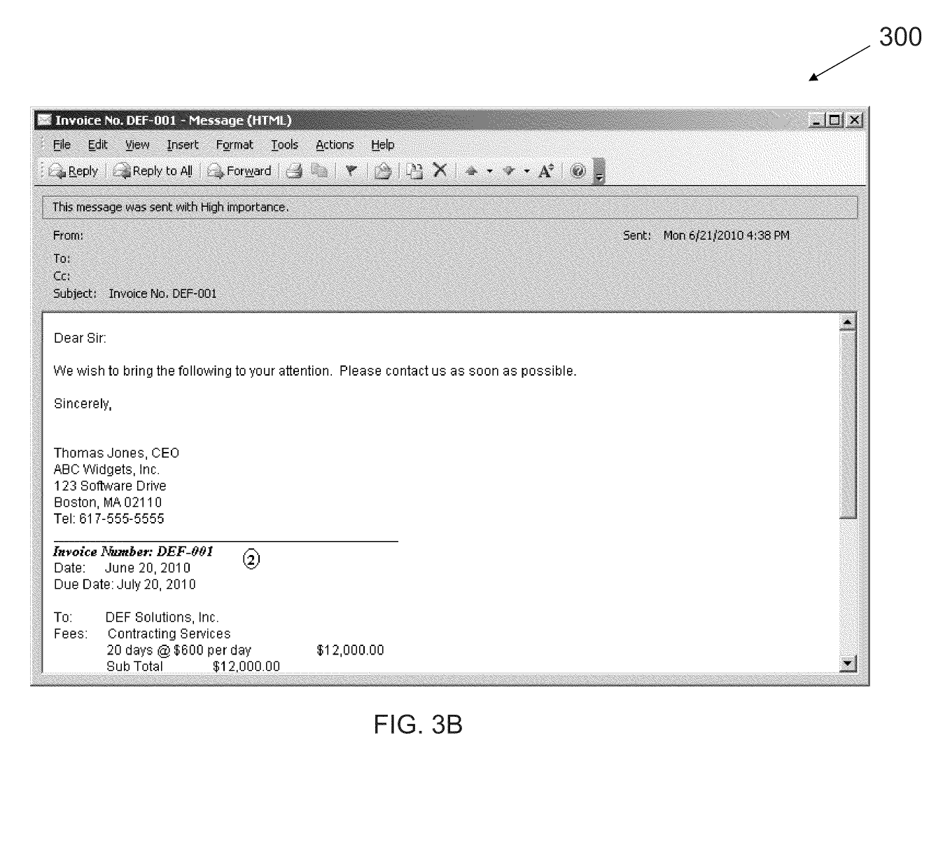

FIGS. 3A and 3B are screenshots of an email message 300, wherein contents of the email message are selected by a first user and a second user, in accordance with principles of the invention. In the illustrated example, an email message is produced by an author. The author sends the email to users identified in an email distribution list, which can include the first user, the second user, and/or other recipients. The author may copy himself so that he receives the email message. Accordingly, the author may likewise select content of the email message in accordance with principles of the invention.

In FIG. 3A, the first user reads the email message and selects relevant content of the email, specifically, the addressee “Thomas Jones, CEO ABC Widgets, Inc.” displayed in the email message. The content is selected, for example, by highlighting with a mouse and pointer. The content can be identified in a highlighted color that is different than the other text, by background color surrounding the identified content, or by underlining, italicizing, otherwise changing the identified content relative to the other content in the email message.

The selected content can also be categorized as being of “high importance” by right clicking the highlighted text, wherein a button can appear on the display (not shown), for example, in a context menu on the display, metadata is assigned to the content indicating whether the highlighted text is considered by the first user to be of “high importance.” The email message and/or metadata can be stored locally on the same user device as that comprising the email application, or stored on an email server, database, or other repository.

Subsequently, when the first user performs a keyword search for the term “Thomas Jones,” a listing of one or more email messages appears in the search results. However, the listing of the email message 300 appears in the search results prior to other email messages containing the same term, i.e., “Thomas Jones.”

Accordingly, the present invention permits emails containing the search term “Thomas Jones” to be returned in the search results. However, any document where the search term is found in the selected content, for example, email message 300 selectively highlighted with “Thomas Jones” is returned at or near the top of the search results, and indicated as containing high priority matching content, for example, shown by a icon, bold text, or other indicator. The selected content can be highlighted by changing the background of the content or changing the appearance of the selected content.

In contrast, if the searched term “Thomas Jones” is found in another email message also containing content indicated as high importance, however the term “Thomas Jones” is not contained in the indicated high importance text, and thus not assigned with metadata, the document may appear in the search results, but appears lower in the search results than email 300. This is directly due to the fact that while the message may contain high importance text, the high importance text does not relate to the search terms and thus does not apply to the matching results priority.

As shown in FIG. 3B, a second user can receive the email message 300 from the author. However, the second user is interested in the contents of the email message 300 for different reasons than the first user. Accordingly, the second user is interested in the invoice number identified in the email message 300, and accordingly selects the term “Invoice Number: DEF-001” as being highly important. The second user selects this term, categorizes the term as being of high importance, and performs subsequent searches for the term “DEF-001” in a similar manner as that described above with regard to the first user.

While the invention has been shown and described with reference to specific embodiments, it should be understood by those skilled in the art that various changes in form and detail may be made therein without departing from the spirit and scope of the invention.

What is claimed is:

1. A computer-implemented method of managing a plurality of electronic documents, the method comprising:
receiving content selected from a first electronic document;
generating metadata corresponding to the received content and a location of the received content in the first electronic document;
storing the metadata;
receiving a search term that is also in the received content; and
displaying search results in response to a search against a repository, the search results including an indicator of the first electronic document and further including an indicator of a second electronic document that includes the search term, wherein the indicator of the first electronic document is displayed higher in the search results than the second electronic document.

2. The computer-implemented method of claim 1, wherein the selected content in the first electronic document is highlighted as high priority content.

3. The computer-implemented method of claim 2, wherein the background of the selected content is highlighted.

4. The computer-implemented method of claim 1, wherein the font of the selected content is different than the font of the unselected content of the first electronic document.

5. The computer-implemented method of claim 1, wherein the first electronic document is an email message.

6. The computer-implemented method of claim 1, wherein the metadata include information regarding the relevance or importance of the selected content.

7. The computer-implemented method of claim 1, wherein the email message is sent to a plurality of recipients, and wherein a first recipient selects different content from the email message than a second recipient.

8. The computer-implemented method of claim 1, wherein the indicator of the first electronic document includes a name of the first electronic document.

9. The computer-implemented method of claim 1 wherein the second electronic document has a selected content and the search term is not within the selected content.

10. A document management system comprising:
a document manager that receives from a user device content selected from a first electronic document and that generates metadata corresponding to the received content and a location of the received content in the first electronic document; and
a data repository that stores the metadata, wherein when a search is performed against a repository for electronic documents that include a search term, an indicator of the first electronic document is displayed in the user device higher in the search results than an indicator of a second electronic document that includes the search term.

11. The document management system of claim 10, wherein the selected content in the first electronic document is highlighted as high priority content.

12. The document management system of claim 11, wherein the background of the selected content is highlighted.

13. The document management system of claim 10, wherein the first electronic document is an email message.

14. The document management system of claim 10, wherein the metadata includes information regarding the relevance or importance of the selected content.

15. The document management system of claim 10, wherein the email message is sent to a plurality of recipients, and wherein a first recipient selects different content from the email message than a second recipient.

16. The document management system of claim 10, wherein the indicator of the first electronic document includes a name of the first electronic document.

17. The document management system of claim 10, wherein the search includes searching contents of the plurality of electronic documents that include the search term.

18. A computer program product for managing a plurality of electronic documents, the computer program product comprising:
a computer readable storage medium having computer readable program code embodied therewith, the computer readable program code comprising:
computer readable program code configured to receive content selected from a first electronic document;
computer readable program code configured to generate metadata corresponding to the received content and a location of the received content in the first electronic document;
computer readable program code configured to store the metadata;
computer readable program code configured to subsequently receive a search term; and
computer readable program code configured to display search results in response to a search, the search results including an indicator of the first electronic document and further including an indicator of a second electronic document including the search term, wherein the indicator of the first electronic document is displayed higher in the search results than the second electronic document.

19. The computer program product of claim 18, wherein the first electronic document is an email message.

20. The computer program product of claim 18, wherein the metadata includes information regarding the relevance or importance of the selected content.
